(19) United States
(12) Patent Application Publication
(10) Pub. No.: US 2023/0344074 A1
(43) Pub. Date: Oct. 26, 2023

(54) APPARATUS FOR SUPPRESSING A BATTERY FIRE

(71) Applicant: CellBlock FCS, LLC, Standish, ME (US)

(72) Inventors: Dylan Francis VANDEMARK, Hiram, ME (US); Mathew Lloyd VANDEMARK, Hiram, ME (US)

(73) Assignee: CellBlock FCS, LLC, Standish, ME (US)

(21) Appl. No.: 17/725,095

(22) Filed: Apr. 20, 2022

(51) Int. Cl. H01M 50/383; H01M 50/375; H01M 50/342; H01M 50/22; H01M 50/273

(52) U.S. Cl. CPC H01M 50/383; H01M 50/375; H01M 50/342; H01M 50/22; H01M 50/273

(57) ABSTRACT

An apparatus for storing and/or charging lithium-ion batteries, the apparatus having one or more enclosures for receiving a battery, each of the enclosures having a common wall disposed between the top and the bottom of the enclosure, the common wall has openings that extend through it, a free-flowing granulate having fire extinguishing properties is associated with the common wall and a barrier formed from a material that disintegrates upon exposure to heat covers at least some of the common wall openings so that when a battery fire occurs, the barrier is caused to disintegrate and the granulate will pass through the common wall openings and onto the fire.

### FIELD OF THE INVENTION

This invention relates to a battery storage apparatus for suppressing a fire, and particularly a fire caused by a lithium-ion battery.

### BACKGROUND OF THE INVENTION

Lithium-ion batteries are used in a wide variety of consumer electronics. Depending upon the power requirements of the device, a higher watt-hour battery may be preferred. Watt-hours represents the capacity of a given battery and high watt-hour batteries provide a longer run time and generate more work than a comparably sized lower watt-hour battery. High watt-hour lithium-ion batteries are especially preferred in e-scooters, e-bikes and other e-mobile devices.

Companies that rely on e-mobile devices in their day-to-day operation use charging racks that allow multiple high watt-hour batteries to be individually charged at the same time.

If improperly handled, manufactured, or overcharged, lithium-ion batteries experience thermal runaway i.e., the battery spontaneously self-heats and increases in temperature which in turn causes a chemical reaction to occur followed by the release of flammable and toxic gases. Lithium-ion fluid inside of the battery is ignited and substantial energy is released i.e., temperatures in excess of 2,000 degrees Fahrenheit. Although it may be possible to extinguish a lithium battery fire with large amounts of water, the lithium in the battery may react with electrolytes in the water and generate hydrogen gas that will accelerate the fire. Sand and similar materials may be applied to the fire; however, these materials are merely fire resistant and lack fire extinguishing properties.

Thermal runaway is a significant threat in the case of high watt-hour batteries. Without appropriate safety measures, recharging high watt-hour batteries in a charging apparatus poses a dormant but potentially catastrophic threat to a business.

Prior art attempts to provide fire mitigation and extinguishing measures in lithium battery storage and charging racks include fire resistant barriers placed between adjacent batteries, applying cooling air to vent the toxic gasses, and providing electronic sensors to detect heat or smoke and then release a fire extinguishing material. The prior art devices are unduly complex, costly to manufacture, and unreliable due to the extreme temperatures and unpredictable nature of a thermal runaway fire.

A need exists for a battery storage and/or charging apparatus that overcomes the deficiencies of the prior art with respect to fire mitigation.

### BRIEF SUMMARY OF THE INVENTION

One aspect of the present invention is an apparatus adapted to extinguish a battery fire, especially a lithium battery fire, the apparatus comprises at least one enclosure for receiving a battery to be stored and/or charged, the enclosure having a top, a bottom, and side walls, a divider wall is disposed between the enclosure top and bottom, the divider wall having openings that extend through it, a free-flowing expanded glass granulate having fire extinguishing properties is disposed between the enclosure top and the divider, a barrier is provided between the expanded glass granulate and the divider wall holes, the barrier is formed from a material that disintegrates upon exposure to heat so that when a fire erupts inside of the enclosure, the barrier will disintegrate and the expanded glass granulate will pass through the openings of the divider wall and onto the fire.

Another aspect of the present invention is a battery storage apparatus comprising at least one enclosure for receiving a battery, the enclosure having a top, a bottom, and side walls, a deployment shelf, the shelf is disposed within the enclosure and between the enclosure top and bottom, the shelf has openings that extend through it, a free flowing granulate having fire suppression properties is provided on the shelf, and a barrier is disposed between the shelf and the granulate and is formed from a material that disintegrates upon exposure to heat whereby when a fire occurs within the enclosure, the barrier will disintegrate and the granulate is released so that it passes through the shelf openings and onto the fire.

A further aspect of the invention is a battery storage rack comprising a first receptacle for receiving a battery, a second receptacle disposed adjacent the first receptacle, the second receptacle including a free flowing granulate having fire suppression properties, the first receptacle includes a common wall disposed between the first receptacle and the second receptacle, the common wall has openings that extend through it and a material that disintegrates upon exposure to heat whereby when a fire occurs within the first receptacle, the common wall material is caused to disintegrate and the granulate will pass through the openings and onto the fire to suppress it.

A still further aspect of the present invention is a battery storage rack comprising an array of separate enclosures for receiving separate batteries, each of the separate enclosures has a top, a bottom, and side walls, a deployment shelf is disposed within each of the separate enclosures and between the top and bottom of each of the separate enclosures, the shelf has openings that extend through it, a free flowing granulate having fire suppression properties is provided on each shelf of the separate enclosures, and a barrier is disposed between each shelf and the granulate, the barrier is formed from a material that disintegrates upon exposure to heat so that when a fire occurs within one of the separate enclosures, the barrier in it will disintegrate and the granulate will pass through the shelf openings and onto the fire.

This summary does not necessarily describe the entire scope of all aspects. Other aspects, features and advantages will be apparent to those of ordinary skill in the art from the following description of the specific embodiments.

### BRIEF DESCRIPTION OF THE SEVERAL VIEWS OF THE DRAWINGS

FIG. 1 is a front perspective view showing an embodiment of a storage and charging apparatus according to the present invention with the enclosure gate shown in an open position and the batteries shown in phantom lines;

FIG. 2 is rear perspective view of the shipping container shown in FIG. 1 with the charging cords shown in phantom lines;

FIG. 3 is a front plan view of the apparatus shown in FIG. 1;

FIG. 4 is a side plan view of the apparatus shown in FIG. 4;

FIG. 5 is a cross-sectional view of the apparatus in FIG. 3, taken along lines 5-5;

FIG. 6 is a perspective view of expanded glass granulate encased within an elongated container;

FIG. 7 is a cross-sectional view of the apparatus in FIG. 4, taken along lines 7-7;

FIG. 8 illustrates the apparatus in FIG. 4 during a fire event;

FIG. 9 is front plan view showing another embodiment of the present invention with portions of the apparatus broken away;

FIG. 10 is perspective view of another embodiment of the present invention where the barrier is a sheet material;

FIG. 11 is a cross-sectional view of the apparatus in FIG. 9, taken along lines 11-11;

FIG. 12 is another embodiment of the apparatus shown FIG. 7;

FIG. 13 is the apparatus in FIG. 12 during a fire event;

FIG. 14 is a front perspective view of the apparatus shown in FIG. 1 in combination with a cover; and

FIG. 15 is a rear perspective view of the apparatus shown in FIG. 2 in combination with a cover.

### DETAILED DESCRIPTION OF THE INVENTION

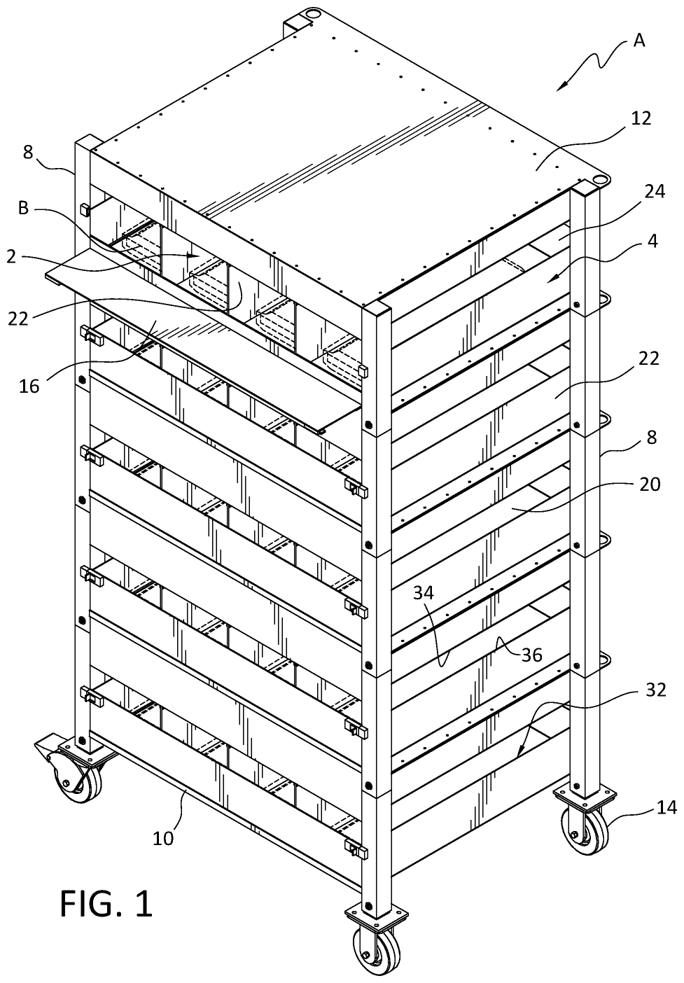

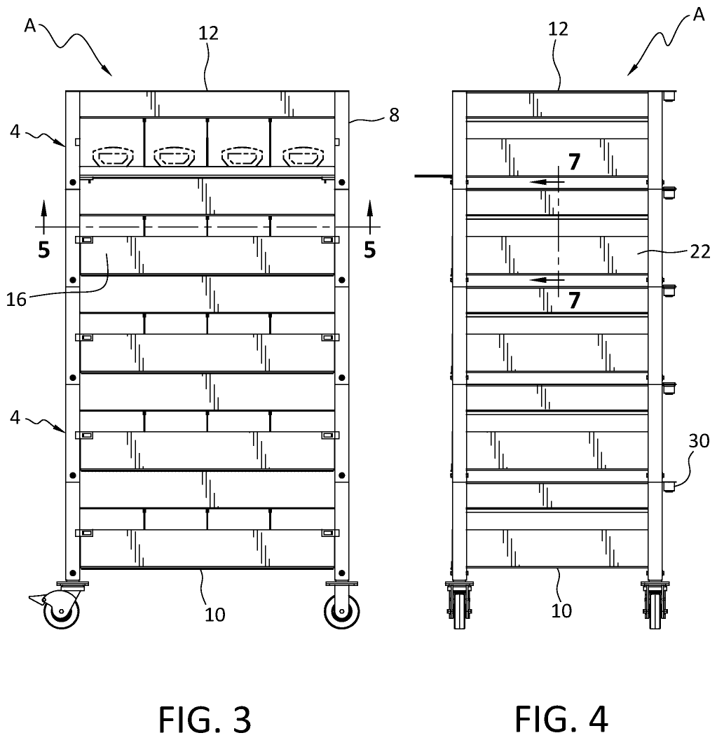

Referring to FIGS. 1 through 4, and according to a first embodiment of the present invention, a battery storage and charging apparatus A is shown. The battery storage and charging apparatus A in this embodiment is a rack assembly having enclosures 2 where lithium-ion batteries B are separately placed for storage and charging. The separate enclosures 2 are aligned in rows on each shelf 4 of the apparatus A. As is apparent, variations of the rack assembly are within the scope of the present invention depending upon end use requirements. For example, the apparatus may comprise a single shelf 4 containing enclosures 2, or each shelf 4 may house a different number of lithium-ion battery enclosures 2 than that as shown and the number and position of the charging cords 6 may be adjusted accordingly. The rack assembly may provide storage of a lithium-ion battery without a battery charging function.

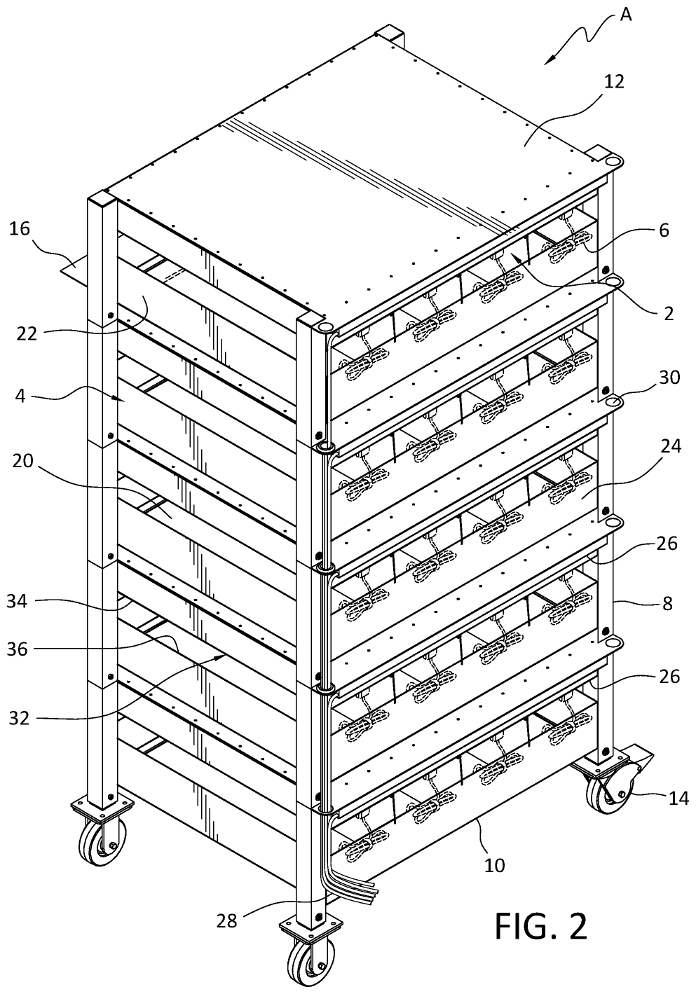

Referring to FIGS. 1 and 2, charging rack assembly A generally comprises a frame 8 that supports a series of vertically stacked individual shelves 4. The charging rack is provided with a base 10, a top 12, left and right sides, a front (FIG. 1), and a back (FIG. 2). Optional castor type wheels 14 may be provided for mobility. As noted earlier, each shelf 4 is shown to include four battery enclosures 2 that extend from the front to the back of the rack assembly. In alternative embodiments (not shown), each shelf may house a different number of battery enclosures 2.

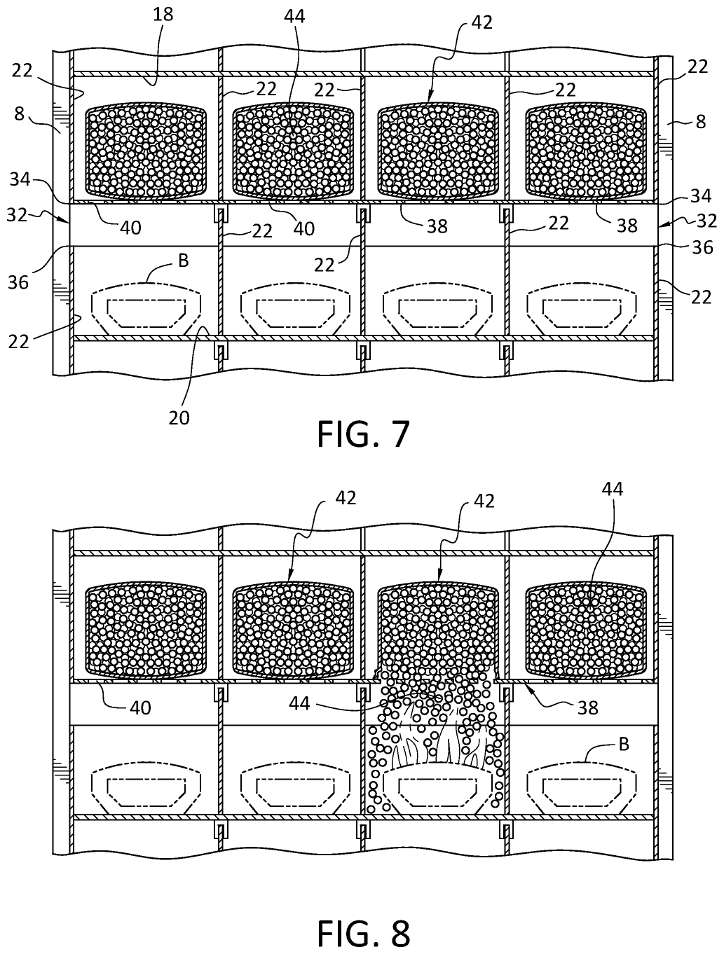

Each enclosure 2 has a top 18, a bottom 20, a front side 16, left and right sides 22, and a back side 24. The front side 16 may be hingedly connected so that it pivots between an open and closed positon as shown in the figures. Front side 16 may be provided with a latch or similar mechanism for locking it when in a closed or upright position. As best shown in FIGS. 1 and 2, the front sides 16, left and right sides 22, and back sides 24 adjacent the perimeter of each shelf 4 do not fully extend to top 18. The left and right sides 22 of enclosures 2 that are not adjacent frame 8 do extend to top 18 (FIG. 7). It is within the scope of the present invention to extend the left and the right side walls 22 of each enclosure 2 to its respective top 18 or to not extend the left and right side walls of each enclosure 2 to its respective top. Enclosure 2 is preferably constructed from a fire-resistant material such as powder coated steel or other material having sufficient fire proof or fire resistant characteristics.

FIG. 2 shows the enclosure 2 may be provided with a charging cord 6 for connection to a battery. 110V power strips 26 are associated with each shelf 4 to provide an electrical connection to each charging cord 6. The cords 28 of the power strips 26 are shown to extend through sleeve members 30 that are provided on each shelf 4.

FIG. 7 shows the enclosure 2 in greater detail. Each enclosure 2 has a top 18, a bottom 20, and left and right sides 22 that extend from the bottom 20 to the top 18 except in the case when one of the left and right sides 22 is provided with an open region 32 that is disposed between ends 34 and 36 of side 22.

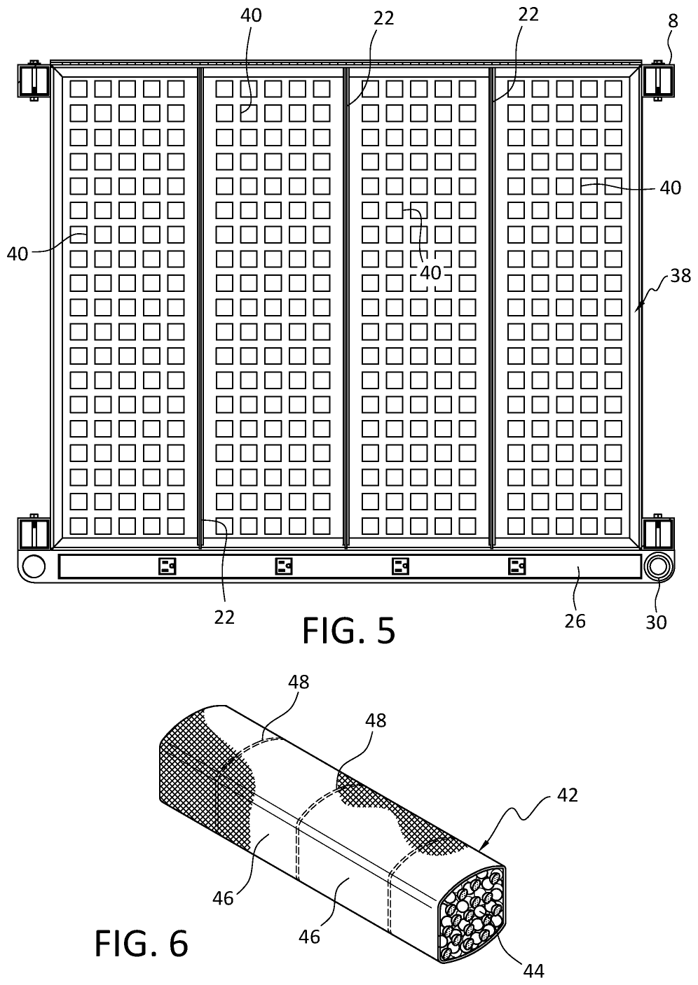

As best shown in FIGS. 5 and 7, a deployment shelf or common wall 38 is provided within each enclosure 2 between the top 18 and bottom 20 of the enclosure 2, dividing the enclosure 2 into an upper region or receptacle that where the fire suppression media is provided and a lower region or receptacle where the battery B is received. The shelf or common wall 38 is provided with a series of openings 40 that extend through it. As is apparent, the shape and size of the openings may vary depending upon design characteristics, for example, to accommodate a specific granulate size or suppression media. The essential feature being the openings are of a sufficient number and size so that the fire suppression media associated with the upper region will be efficiently dispersed during a fire event and as will be further explained below.

Turning to FIGS. 6 and 7, a container 42 is provided on top of the deployment shelf 38 and in the upper region of the enclosure 2. Container 42 is filled with the fire suppression media, preferable, a free flowing, expanded glass granulate 44 and functions as a barrier that prevents the expanded glass granulate 44 from passing through openings 40. Container 42 is constructed from a heat sensitive material that is combustible or otherwise disintegrates upon exposure to a flame or heat. In a preferred embodiment, the container 42 is constructed from a 100% polyester fabric that has been coated with a PVC resin to increase its sensitivity to heat and flames. Other flammable fabrics and materials (e.g., cotton) are within the scope of the invention. The container extends from the back to the front of the enclosure 2 and contain a sufficient amount of the fire suppression media so that a battery fire can be extinguished.

As best shown in FIGS. 6, the interior of container 42 may contain separate compartments 46 between interior walls 48 to evenly distribute the free-flowing expanded glass granulate 44 within the compartments and prevent excessive shifting. It is within the scope of the invention to not provide compartments depending upon design requirements. For example, if container 42 is filled to a maximum, the expanded glass granulate is less likely to shift inside the container. The container 42 is shown in the figures to have an elongated shape. It is within the scope of the invention to provide additional containers 42 in the upper region of each enclosure or to vary the shape of the container from that as shown. The essential requirement is container retains a sufficient quantity of the expanded glass granulate.

As noted earlier, container 42 is preferably filled with a dry, free flowing, expanded glass granulate. The granules are relatively small, lightweight spheres of expanded (i.e., foamed) silicon dioxide glass having interior pores that provide a closed cell structure. The granules readily absorb any heat and smoke and actively extinguish a fire by displacing oxygen and melting onto an ignited lithium-ion battery or device containing such a battery. The sizing of the aggregate correlates to its interior pore size and hence its relatively low density that enhances its utility as a reactive fire extinguisher. A commercially available expanded glass granulate suitable for use in the present invention is sold by CellBlock FCS under their CELLBLOCK EX trademark and is incorporated herein by reference. Other fire suppression media are within the scope of the present invention provided it can be deployed onto a fire in the manner as set forth in this disclosure.

The size of the free-flowing expanded glass granulate of the present invention is preferably non-uniform and comprises a blend of varying granules sizes. The smallest size granules have relatively greater density and a smaller pore size while the largest sized granules have the lower density and a larger pore size. In a preferred embodiment, the size of the expanded glass granulate is between about 1 mm diameter to about 4 mm in diameter. A suitable composition for the granulate is a blend of 1 mm, 2 mm, 3 mm and 4 mm diameter size spheres combined in a 1:1:1:1 ratio. The preferred blend has a total air content of about 70-80% by volume and an average density of about 10 bs/ft\hat{ }3 to promote sufficient absorption of heat, provide enhanced insulative properties from the heat of the fire and also provide low heat transference. The intense heat generated by a lithium battery fire will cause at least some of the granules to melt, however no toxic byproduct is produced.

As best shown in FIG. 8, when a lithium-ion battery within the lower region of an enclosure 2 begins to combust due to, for example, a thermal runway event, the heat released at the outset will disintegrate the sacrificial material forming container 42 in the upper region of the enclosure and cause release of the expanded glass granulate 44 so that it will pass through the sufficiently large openings 40 of shelf or common wall 38 and onto the fire. Gas released during the thermal runaway event is absorbed by the expanded glass granulate 44 and the granulate will smother the battery and absorb the heat generated through direct contact. Shortly afterwards, oxygen to the fire is cut off and the fire is suppressed. Batteries in adjacent enclosures 2 are prevented from erupting into flames due to shielding provided by the side walls 22 between adjacent battery compartments. Further, fire suppression media disposed above other batteries within other adjacent enclosures 2 may be released if the battery fire generates sufficient heat. As is apparent, once the fire is suppressed, the enclosure may be cleared of debris and be recharged with fresh expanded glass granulate or other fire suppression media.

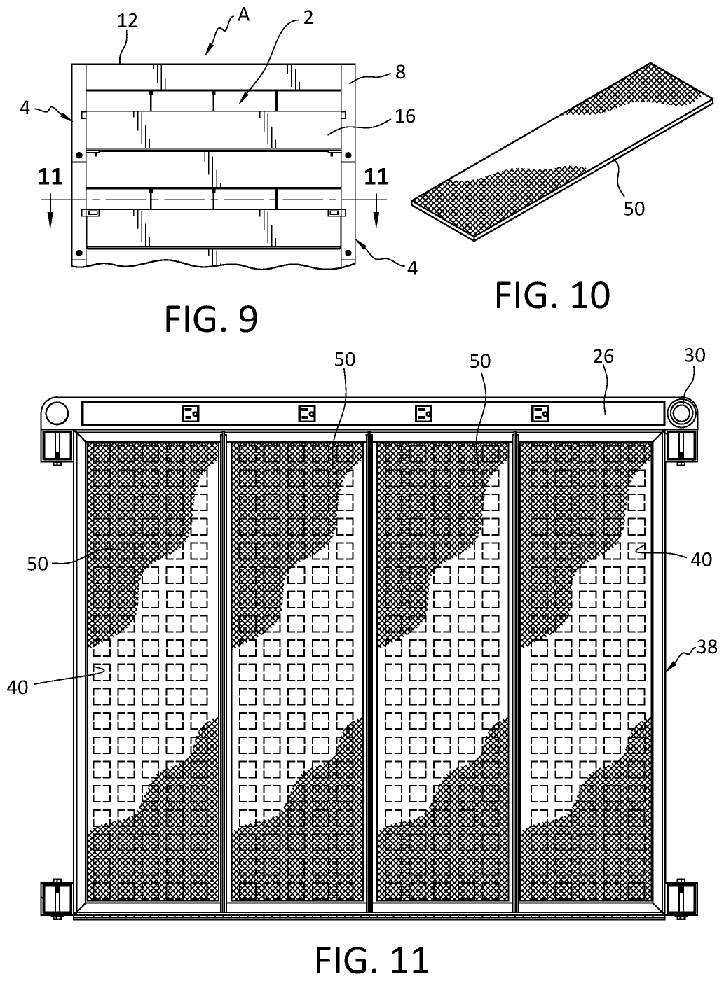

Another embodiment of the invention is shown in FIGS. 9 through 13. In this embodiment and as best shown in FIGS. 10 and 11, a planar sheet 50 is placed on the top of the shelf or common wall 38 and in the upper region of the enclosure 2 so that it overlies openings 40. Turning to FIG. 12, the fire suppression media, preferable, a free flowing, expanded glass granulate 44 is placed on sheet 50 and withholds the expanded glass granulate 44 from passing through the openings 40 of shelf or common wall 38. Sheet 50 is constructed from a heat sensitive material that is combustible or will otherwise disintegrate when exposed to a flame or high heat. In a preferred embodiment, sheet 50 is constructed from a 100% polyester fabric that has been coated with a PVC resin to increase its sensitivity to heat or flames. Other flammable fabrics and materials (e.g., cotton) are within the scope of the invention. As is apparent, other embodiments for preventing the granulate from passing through the openings are within the scope of the present invention. For example, the shelf or common wall may be entirely formed from a heat sensitive material or each opening 40 in the shelf may be provided with its own sacrificial material in the form of a plug as opposed to a single sheet.

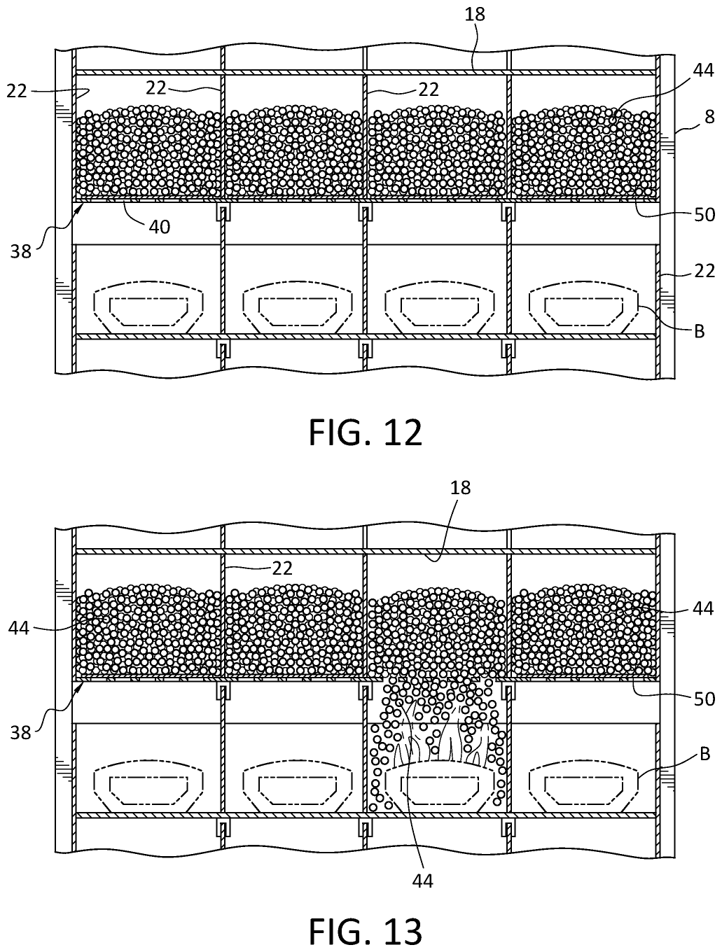

As best shown in FIG. 13, when a lithium ion battery within an enclosure 2 begins to combusts due to, for example, a thermal runway event, the heat released at the outset of the event will cause the sacrificial material of sheet 50 to disintegrate and the expanded glass granulate 44 will be released so that it may freely pass through the openings 40 of shelf or common wall 38 and be distributed onto the battery fire to suppress it.

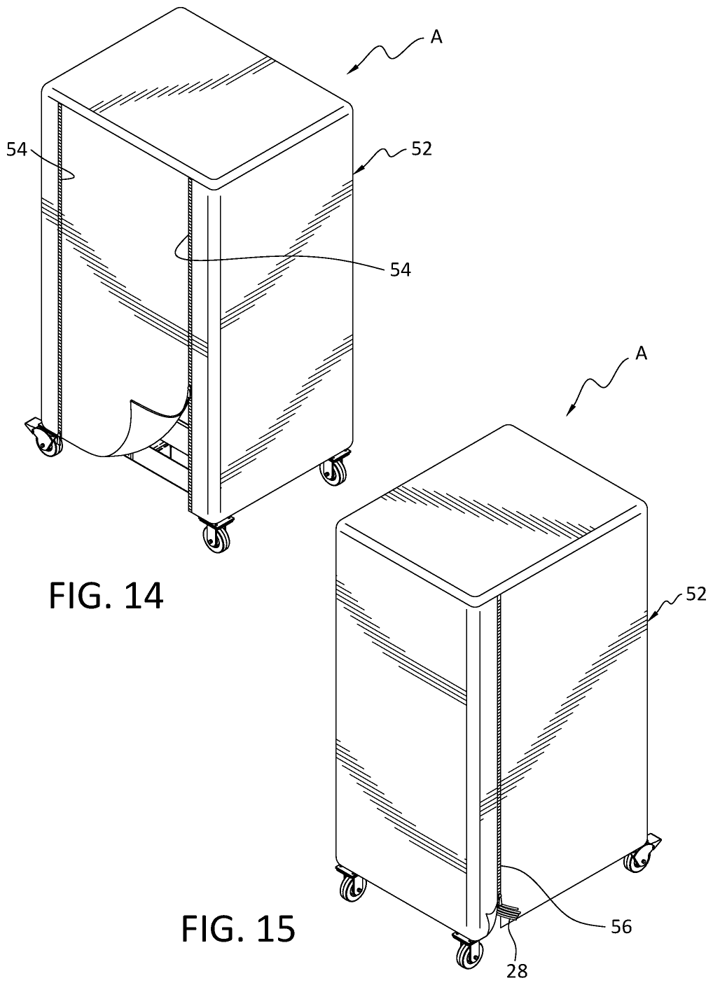

Another embodiment of the invention is shown in FIGS. 14 and 15 where a fire-resistant cover 52 is provided for placement over the storage/charging rack A. FIG. 14 shows the front of the cover 52 is provided with a pair of zippers 54 that allow the unzipped front panel of the cover to be rolled up (now shown) so that access to the battery enclosures 2 is proviced. FIG. 16 shows the back of the cover 52 is provided with a zipper 56 that permits access to the power cords 28. The fire-resistant cover 52 is preferably constructed from a fire-resistant material, for example, a material manufactured by DuPont and sold under their NOMEX trademark. Other materials having fire-resistant characteristics are within the scope of the present invention. For example, the fire-resistant material may be KEVLAR, ARAMID, a carbon fiber material, a silicate fiber material or combinations of these materials. Cover 52 provides supplemental protection in the event of a fire event by containing flames or projectiles while the battery fire is being suppressed.

The terminology used in this application is for the purpose of describing specific embodiments and is not intended to be limiting. Directional terms such as “above”, “below” “upper”, “lower”, “horizontal”, “vertical”, “left”, and “right” are for relative reference only and to assist the reader in understanding the embodiments and are not intended to restrict the orientation of any structure or its use relative to the environment. Singular forms of “a”, “an”, and “the”, are intended to include plural forms as well, unless the context clearly indicates otherwise. Terms such as “comprises,” “comprising”, “including” and “includes”, and “having”, when used in the specification, specify the presence of one or more stated features, elements or steps and do not preclude the presence of an addition of one or more other features, elements or steps.

While this invention has been described as having a preferred design, it is capable of further modifications, uses and adaptations, both in whole and in part, while following the general principle of the invention including such departures from the present disclosure as is known or is customary practice in the art to which this invention pertains, and as may be applied to the central features of this invention.

We claim:

1. A battery storage apparatus, comprising:
a) at least one enclosure for receiving a battery, the enclosure having a top, a bottom, and side walls;
b) a deployment shelf, the shelf is disposed within the enclosure and between the enclosure top and bottom, the shelf has openings that extend through it;
c) a free flowing granulate having fire suppression properties, the granulate is on the shelf; and
d) a barrier, the barrier is between the shelf and the granulate and is formed from a material that disintegrates upon exposure to heat whereby when a fire occurs within the enclosure, the barrier will disintegrate and the granulate will pass through the shelf openings and onto the fire.

2. The apparatus as in claim 1 and wherein the shelf extends to the side walls of the enclosure.

3. The apparatus as in claim 1 and wherein the barrier comprises one of a sheet or a container.

4. The apparatus as in claim 1 and wherein the free flowing granulate comprises foamed silicon dioxide glass spheres.

5. The apparatus as in claim 1 and wherein the barrier material is a flammable material.

6. The apparatus as in claim 1 and wherein the container side walls extend from the container top to the container bottom.

7. The apparatus as in claim 1 and further including a second enclosure adjacent the at least one enclosure and wherein both enclosures share the same side wall.

8. The apparatus as in claim 1 and further comprising at least one battery charging cord, the battery charging cord is associated with the at least one enclosure for connection to a battery disposed within the enclosure.

9. The apparatus as in claim 7 and further comprising additional enclosures, the additional enclosures are disposed on top of or beneath the at least one enclosure and the second enclosure.

10. A battery storage rack, comprising:
a) a first receptacle for receiving a battery;
b) a second receptacle disposed adjacent the first receptacle, the second receptacle including a free flowing granulate having fire suppression properties; and
d) the first receptacle including a common wall disposed between the first receptacle and the second receptacle, the common wall having openings that extend through it and a material that disintegrates upon exposure to heat whereby when a fire occurs within the first receptacle, the common wall material is caused to disintegrate and the granulate will pass through the common wall openings and onto the fire to suppress it.

11. The battery rack as in claim 10 and wherein the second receptacle is above the first receptacle.

12. The battery storage rack as in claim 10 and wherein the common wall material that disintegrates comprises one of a sheet or a container.

13. The battery storage rack as in claim 10 and wherein the free flowing granulate comprises foamed silicon dioxide glass spheres.

14. The battery storage rack as in claim 10 and wherein the common wall material that disintegrates is a flammable material.

15. The battery storage rack as in claim 10 and further comprising additional first and second receptacles, the additional first and second receptacles are adjacent the first and second receptacles.

16. The battery storage rack as in claim 10 and further comprising at least one battery charging cord, the battery charging cord is associated with the first receptacle for connection to a battery.

17. The battery storage rack as in claim 10 and further comprising a removable cover member, the cover surrounds the first and second receptacles and is fire resistant.

18. A battery storage rack, comprising:
a) an array of separate enclosures for receiving separate batteries, each of the separate enclosures having a top, a bottom, and side walls;
b) a deployment shelf, the shelf is disposed within each of the separate enclosures and between the enclosure top and bottom, the shelf has openings that extend through it;
c) a free flowing granulate having fire suppression properties, the granulate is on the shelf of each of the separate enclosures; and
d) a barrier, the barrier is between the shelf and the granulate of each separate enclosure and is formed from a material that disintegrates upon exposure to heat whereby when a fire occurs within the separate enclosures, the barrier will disintegrate and the granulate will be released through the shelf openings and onto the fire.

19. The battery storage rack as in claim 18 and wherein the barrier comprises one of a sheet or a container.

20. The battery storage rack as in claim 18 and wherein the free flowing granulate comprises foamed silicon dioxide glass spheres.
